(19) United States
(12) Patent Application Publication
(10) Pub. No.: US 2026/0216827 A1
(43) Pub. Date: Jul. 30, 2026

(54) CALCULATING METHOD, DETECTING APPARATUS, AND CHIP MANUFACTURING METHOD

(71) Applicant: DISCO CORPORATION, Tokyo (JP)

(72) Inventors: Yutaro NOMURA, Tokyo (JP); Takayuki MASADA, Tokyo (JP)

(21) Appl. No.: 19/430,904

(22) Filed: Dec. 23, 2025

(30) Foreign Application Priority Data
Jan. 27, 2025 (JP) 2025-011449

(51) Int. Cl. B23K 26/364; G01B 11/06; G01S 17/42

(52) U.S. Cl. CPC B23K 26/364; G01B 11/0608; G01S 17/42

(57) ABSTRACT

A calculating method of calculating a shape of a groove formed along a direction parallel to a front surface of a plate-shaped workpiece including positioning a distance measuring unit in such a manner as to face part of the groove of the plate-shaped workpiece, acquiring, with use of the distance measuring unit, information regarding a height of each of two or more of measurement points set in the groove such that positions of the measurement points in a width direction of the groove are different from each other, and calculating the shape of the groove according to the acquired information regarding the height of each of the measurement points.

### BACKGROUND OF THE INVENTION

### Field of the Invention

The present invention relates to a calculating method which calculates a shape of a groove in a plate-shaped workpiece in which the groove is formed along a direction parallel to a front surface of the plate-shaped workpiece, a detecting apparatus, a chip manufacturing method which divides the plate-shaped workpiece along a plurality of dividing lines set on the plate-shaped workpiece to manufacture chips.

### Description of the related Art

In a manufacturing process for device chips to be used for electric equipment such as a mobile phone or a personal computer, first, a plurality of dividing lines (streets) that cross each other are set on a front surface of a wafer made of a semiconductor or the like. The devices such as integrated circuits (ICs) and large-scale integration (LSI) circuits are formed in respective regions partitioned by the dividing lines. Then, by dividing the wafer along the dividing lines, individual device chips are formed. Division of the plate-shaped workpiece such as a wafer is performed by cutting the plate-shaped workpiece along the dividing lines with a cutting blade including a segment portion in an annular pattern. The plate-shaped workpiece is cut from the front surface to a back surface thereof with the cutting blade, that is, is subjected to full cutting, and dividing grooves are formed in the plate-shaped workpiece along the dividing lines. In general, an outer circumferential surface of each of the segment portions of the cutting blade has a cylindrical shape. Specifically, a diameter of the outer circumferential surface of the segment portion is substantially constant at any position of a thickness direction of the segment portion.

When chips are formed by cutting and dividing the plate-shaped workpiece, a sharp angular shape appears at each of the front surface and the back surface of an end portion of the chip. In a case in which an impact is applied to a chip having such an angular shape or such a chip is bent, chipping may occur in the end portion of the chip. In view of this, it is considered that V-shaped grooves are formed in advance along the dividing lines in the front surface or the back surface of the plate-shaped workpiece, that is, bevel cutting is performed, and dividing grooves are formed on the inner side of the V-shaped groove in the plate-shaped workpiece (for example, see Japanese Patent Laid-Open No. Hei6-232255). In this case, an inclined surface arising from the V-shaped groove appears at the end portion of the front surface or the back surface of the chip formed, and chips having the same shape as that having undergone chamfered processing and having corners thereof cut off are manufactured. The chip fabricated in this manner is less likely to develop chipping at the end portion thereof and has a high bending strength. To form a V-shaped groove in the plate-shaped workpiece, for example, a cutting blade with the outer circumferential surface of the segment portion in a shape different from the cylindrical shape is used. More specifically, a cutting blade including a segment portion having a mountain-shaped form with a peak extending all around the segment portion and located at a center of the thickness direction of the outer circumferential surface is used. Such a cutting blade may be called a blade for bevel cutting, in some cases. When the segment portion of the blade for bevel cutting is cut along a plane including its center and its thickness direction, the outer circumference of the segment portion is in an inverted V-shape.

### SUMMARY OF THE INVENTION

When the plate-shaped workpiece formed with the V-shaped grooves along the dividing lines is subjected to full cutting and divided along the grooves, such a precise alignment work that a position of a segment portion of a cutting blade for full cutting is aligned with the center of each of the grooves is needed. In view of this, a position of the lowest point of the groove (groove bottom portion) in the plate-shaped workpiece is required to be identified precisely. In a case in which the centers of the cutting blades for bevel cutting and full cutting are not aligned with each other, when the plate-shaped workpiece is subjected to full cutting, the cutting blade for full cutting does not undergo substantially equal forces from two inclined surfaces (a first side portion and a second side portion) constituting the V-shaped groove, and consequently, a bending stress is applied to the relevant cutting blade. As a result, a processing quality is degraded.

In the past, identification of the position of the V-shaped groove has been performed by imaging the plate-shaped workpiece with a camera. By detecting an end portion of the groove from an image obtained by the capturing, the shape of the groove has been identified. However, when the V-shaped groove is formed with a blade for bevel cutting, chipping may be generated at the end portion of the groove, and precise detection of the end portion of the groove may be difficult. Moreover, both end portions of the groove cannot be within the field of view of the camera, and the end portions of the groove cannot be detected.

Thus, an object of the present invention is to provide a calculating method which is capable of calculating a shape of a groove formed in a plate-shaped workpiece easily and with high accuracy, a detecting apparatus, and a chip manufacturing method which detects the shape of the groove easily and with high accuracy and divides the plate-shaped workpiece into individual pieces to manufacture chips.

In accordance with an aspect of the present invention, there is provided a calculating method of calculating a shape of a groove formed along a direction parallel to a front surface of a plate-shaped workpiece, including positioning a distance measuring unit in such a manner as to face part of the groove of the plate-shaped workpiece, acquiring, with use of the distance measuring unit, information regarding a height of each of two or more of measurement points set in the groove such that positions of the measurement points in a width direction of the groove are different from each other, and calculating the shape of the groove according to the acquired information regarding the height of each of the measurement points.

Preferably, the distance measuring unit is a laser rangefinder.

Moreover, preferably, the distance measuring unit is an imaging camera, and the imaging camera is focused at a specific position, thereby making it possible to determine that the specific position is spaced apart from the imaging camera by a predetermined distance.

In accordance with another aspect of the present invention, there is provided a chip manufacturing method of dividing a plate-shaped workpiece along a plurality of dividing lines set along a front surface of the plate-shaped workpiece to manufacture chips, the method including positioning a distance measuring unit in such a manner as to face part of a groove formed in the plate-shaped workpiece along each of the dividing lines, acquiring, with use of the distance measuring unit, information regarding a height of each of two or more of measurement points set in the groove such that positions of the measurement points in a width direction of the groove are different from each other, calculating a shape of the groove according to the acquired information regarding the height of each of the measurement points, and forming a dividing groove along each of the dividing lines in the plate-shaped workpiece with reference to the calculated shape of the groove and dividing the plate-shaped workpiece to form chips.

Preferably, according to the chip manufacturing method, the dividing groove is formed in the plate-shaped workpiece by any of cutting the plate-shaped workpiece with a cutting blade, applying a laser beam of a wavelength absorbable by the plate-shaped workpiece to the plate-shaped workpiece, focusing a laser beam of a wavelength transmissible through the plate-shaped workpiece in the plate-shaped workpiece to form modified layers in the plate-shaped workpiece and apply an external force to the plate-shaped workpiece formed with the modified layers, and subjecting the plate-shaped workpiece to plasma etching along the dividing lines.

In accordance with a further aspect of the present invention, there is provided a detecting apparatus which detects a shape of a groove formed along a direction parallel to a front surface of a plate-shaped workpiece, including a support table capable of supporting the plate-shaped workpiece and a distance measuring unit which faces the plate-shaped workpiece supported on the support table and measures a distance to a measurement point set in the plate-shaped workpiece. The plate-shaped workpiece is supported on the support table, the distance measuring unit is positioned in such a manner as to face part of a groove of the plate-shaped workpiece, information regarding a height of each of two or more measurement points set on an inner surface of the groove such that positions of the measurement points in a width direction of the groove are different from each other is acquired with use of the distance measuring unit, and the shape of the groove is calculated according to the acquired information regarding the height of each of the measurement points.

In the calculating method, the detecting apparatus, and the chip manufacturing method according to the aspects of the present invention, in the plate-shaped workpiece formed with the groove parallel to the front surface thereof, two or more measurement points are set on the inner surface of the groove such that positions of the measurement points in the width direction of the groove are different from each other. Then, regarding each of the measurement points, the information regarding the height of each of the measurement points is acquired, and according to the acquired information, the shape of the groove is calculated. When the shape of the groove formed in the plate-shaped workpiece is thus calculated, for example, according to the shape of the first side portion and the shape of the second side portion of the groove, the center position of the groove bottom portion in the width direction is calculated. Then, when the plate-shaped workpiece is cut with the center position of the groove bottom portion being aligned with the center of the cutting blade, the plate-shaped workpiece can be subjected to full cutting without a great bending force being applied on the cutting blade.

Hence, according to the present invention, there are provided the calculating method capable of calculating the shape of the groove formed in the plate-shaped workpiece easily and with high accuracy, the detecting apparatus, and the chip manufacturing method which detects the shape of the groove easily and with high accuracy and divides the plate-shaped workpiece into individual pieces to thereby manufacture chips.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating a plate-shaped workpiece;

FIG. 2A is a perspective view schematically illustrating an end portion of part of the plate-shaped workpiece;

FIG. 2B is a cross-sectional view schematically illustrating part of the plate-shaped workpiece.

FIG. 3 is a perspective view schematically illustrating a cutting apparatus (detecting apparatus);

FIG. 4A is a cross-sectional view schematically illustrating the manner in which information regarding the height of each of measurement points set on a first side portion of a groove is acquired at each of the measurement points;

FIG. 4B is a cross-sectional view schematically illustrating the manner in which information regarding the height of each of measurement points set on a second side portion of the groove is acquired at each of the measurement points;

FIG. 5 is a cross-sectional view schematically illustrating how the plate-shaped workpiece is divided;

FIG. 6 is a cross-sectional view schematically illustrating the manner in which information regarding the height of each of the measurement points set on the first side portion and the like of the groove in which a dividing groove is formed is acquired at each of the measurement points;

FIG. 7 is a cross-sectional view schematically illustrating the manner in which information regarding the height of each of the measurement points of the plate-shaped workpiece in which a groove according to a modification example is formed is acquired at each of the measurement points;

FIG. 8A is a cross-sectional view schematically illustrating the manner in which information regarding the height of each of the measurement points of the plate-shaped workpiece in which a groove according to another modification example is formed is acquired at each of the measurement points;

FIG. 8B is a cross-sectional view schematically illustrating the manner in which information regarding the height of each of the measurement points of the plate-shaped workpiece in which a groove according to still another modification example is formed is acquired at each of the measurement points;

FIG. 9 is a flowchart illustrating a flow of steps of a method of manufacturing chips (a method of calculating the shape of the groove formed in the plate-shaped workpiece); and

FIG. 10 is a flowchart illustrating another flow of steps of the method of manufacturing chips (the method of calculating the shape of the groove formed in the plate-shaped workpiece).

### DETAILED DESCRIPTION OF THE PREFERRED EMBODIMENT

A preferred embodiment of the present invention will be described below with reference to the accompanying drawings. A calculating method, a detecting apparatus, and a chip manufacturing method according to the present embodiment calculate a shape of a groove formed in a plate-shaped workpiece.

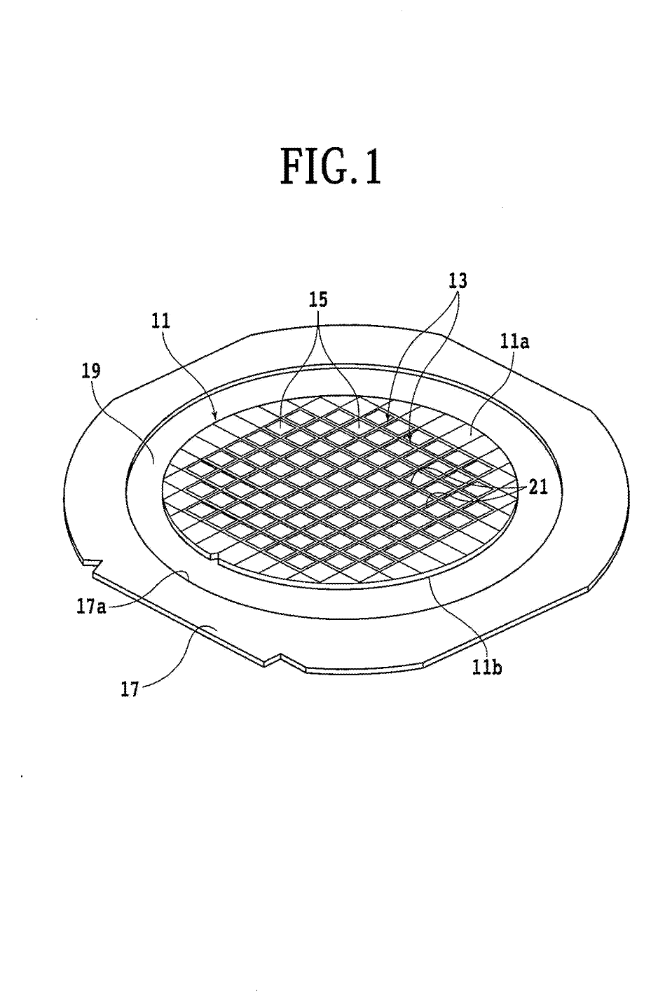

First, the plate-shaped workpiece will be described below. FIG. 1 schematically illustrates a plate-shaped workpiece 11 in perspective. For example, the plate-shaped workpiece 11 is a disk-shaped wafer, for example, made of a semiconductor material such as monocrystalline silicon, and has a front surface 11a and a back surface 11b which lie opposite each other and extend essentially parallel to each other. In addition, the plate-shaped workpiece 11 is demarcated into a plurality of rectangular regions by a plurality of dividing lines (streets) 13 arranged in a lattice manner so as to intersect one another. A device 15 such as an IC, an LSI circuit, a light emitting diode (LED), or a microelectromechanical system (MEMS) device is formed on the front surface 11a of the plate-shaped workpiece 11 in each of the plurality of regions demarcated by the dividing lines 13. However, there are no limitations on the kind, material, shape, structure, size, and the like of the plate-shaped workpiece 11. The plate-shaped workpiece 11 may include a substrate or wafer made of any of semiconductors other than silicon, e.g., gallium arsenide (GaAs), indium phosphorus (InP), gallium nitride (GaN), or silicon carbide (SiC), sapphire, glass, ceramic, resin, or metal, for example. The devices 15 are not limited to any particular types, numbers, shapes, structures, sizes, and layouts, for example. The plate-shaped workpiece 11 may even be free of the devices 15.

A plurality of chips respectively having the devices 15 are manufactured by dividing the plate-shaped workpiece 11 along the dividing lines 13. Division of the plate-shaped workpiece 11 is performed, for example, with use of a cutting apparatus, to be described later, being mounted with a cutting blade which includes grindstones in an annular pattern and cuts the plate-shaped workpiece 11 along the dividing lines 13. When the plate-shaped workpiece 11 is cut, dividing grooves are formed along the dividing lines 13 in the plate-shaped workpiece 11. In general, when the dividing grooves are formed in the plate-shaped workpiece 11 and chips are manufactured, a side surface of each chip is a wall surface vertical to the front surface and the back surface of the chip. Then, an edge having a sharp right-angle corner at the boundary between the side surface and each of the front surface and the back surface of the chip is generated. Hence, when an impact is applied to a chip having such angled edges or such a chip is bent, chipping may occur in the end portion of the chip.

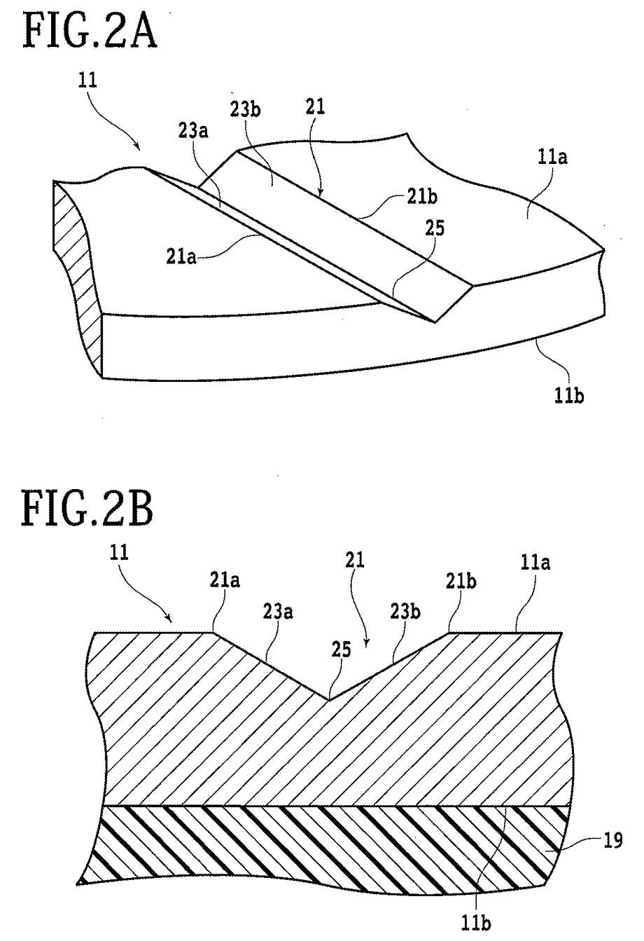

In view of this, it is considered that a groove in a V shape or other shapes is preliminarily formed along each of the dividing lines 13 in the front surface 11a or the back surface 11b of the plate-shaped workpiece 11, that is, the groove is subjected to bevel cutting, and a dividing groove is formed inside the groove in the plate-shaped workpiece 11. In this case, an inclined surface arising from the V-shaped groove appears at the end portion of the front surface side or the back surface side of the chip formed, and a chip having the same shape as that in a case in which a chip whose corners are chamfered is manufactured. The chip fabricated in this manner is less likely to develop chipping at the end portion thereof and has a high bending strength. Specifically, the plate-shaped workpiece 11 has grooves 21 formed therein along the dividing lines 13. In other words, the grooves 21 are formed in a direction parallel to the front surface 11a of the plate-shaped workpiece 11. A cross-sectional shape of each of the grooves 21 is, for example, a V shape. However, as described in detail later, the cross-sectional shape of the groove 21 is not limited to the V shape. FIG. 2A is a perspective view schematically illustrating, in an enlarged manner, an end portion of the plate-shaped workpiece 11 in which the groove 21 is formed, and FIG. 2B is a cross-sectional view schematically illustrating, in an enlarged manner, part of the plate-shaped workpiece 11 in which the groove 21 is formed.

In a case in which the grooves 21 are each in a V shape, each of the grooves 21 has a groove bottom portion 25 linearly extending in a longitudinal direction of the groove 21 (a direction along the dividing lines 13, or a first direction). Further, each of the grooves 21 has a first side portion 23a formed in a region extending from one end portion 21a of the groove 21 in a width direction (a direction parallel to the front surface 11a of the plate-shaped workpiece 11 and perpendicular to the first direction) to the groove bottom portion 25 and a second side portion 23b formed in a region extending from the other end portion 21b thereof in the width direction to the groove bottom portion 25. More specifically, the first side portion 23a and the second side portion 23b are surfaces inclined to the front surface 11a of the plate-shaped workpiece 11. Formation of the V-shaped groove 21 in the plate-shaped workpiece 11 adopts a cutting blade that has an outer circumferential surface of a segment portion different from the cylindrical shape, for example. More specifically, a cutting blade including a segment portion having a mountain-shaped form with a peak extending all around the segment portion and located at a center of the thickness direction of the outer circumferential surface is used. Such a cutting blade may be called a blade for bevel cutting, in some cases. When the segment portion of the blade for bevel cutting is cut along a plane including its center and its thickness direction, the outer circumference of the segment portion is in an inverted V-shape.

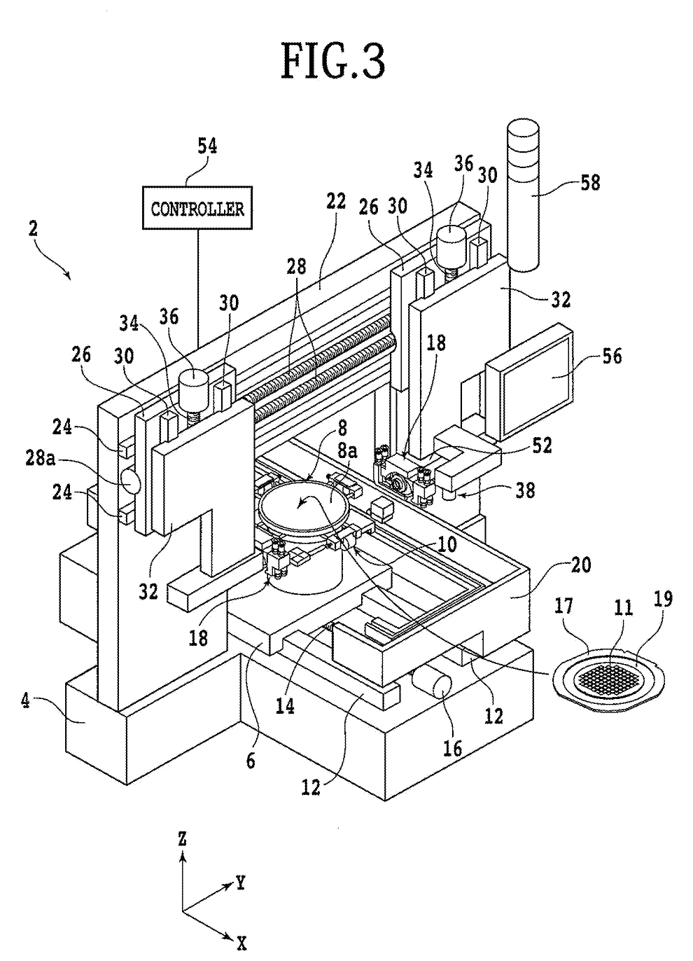

When the plate-shaped workpiece 11 is processed on the cutting apparatus 2 (see FIG. 3), the plate-shaped workpiece 11 is supported on an annular frame 17 (see FIG. 1) for easy handling upon being delivered or held, for example. The frame 17 is made of a metal material such as stainless steel (SUS), for example. The frame 17 has a circular opening 17a defined centrally therein and extending through the frame 17 in the thickness direction. The opening 17a is larger in diameter than the plate-shaped workpiece 11. A circular sheet 19 is fixed to the plate-shaped workpiece 11 and the frame 17. The sheet 19 includes a tape, for example, including a circular film-shaped base and an adhesive layer, i.e., a glue layer, disposed on the base. The base is made of resin such as polyolefin, polyvinyl chloride, or polyethylene terephthalate, for example. Also, the adhesive layer is made of an epoxy-based, acryl-based, or rubber-based adhesive, for example. Note that the adhesive layer may alternatively be made of an ultraviolet-curable resin. The sheet 19 has a central portion affixed to the back surface 11b of the plate-shaped workpiece 11 disposed in the opening 17a in the frame 17 and an outer circumferential portion thereof affixed to a lower surface of the frame 17. The plate-shaped workpiece 11 is thereby supported by the frame 17 via the sheet 19. Note that the groove 21 may be formed in the plate-shaped workpiece 11 in such a state that the plate-shaped workpiece 11 is integrated with the sheet 19 and the frame 17.

Described next is the cutting apparatus which cuts the plate-shaped workpiece 11. FIG. 3 is a perspective view schematically illustrating the cutting apparatus 2. Note that the cutting apparatus 2 described below can function as a detecting apparatus (calculating apparatus) according to the present embodiment. That is, the following description of the cutting apparatus 2 is appropriately referred to as description of the detecting apparatus (calculating apparatus) according to the present embodiment.

As illustrated in FIG. 3, the cutting apparatus 2 includes a base 4 that supports various components thereon. At a central upper portion of the base 4, there are provided an X-axis moving table 6, an X-axis direction moving mechanism which moves the X-axis moving table 6 in an X-axis direction (processing feed direction), and a drain channel 20 which covers the X-axis direction moving mechanism. The X-axis direction moving mechanism includes a pair of X-axis guide rails 12 parallel to the X-axis direction, and the X-axis moving table 6 is slidably attached to the pair of X-axis guide rails 12. In addition, on the lower surface side of the X-axis moving table 6, a nut portion (not illustrated) is provided, and an X-axis ball screw 14 parallel to the X-axis guide rails 12 is screwed into this nut portion. The X-axis ball screw 14 has an axial end coupled to an X-axis stepping motor 16. When the X-axis stepping motor 16 is energized, it rotates the X-axis ball screw 14 about its longitudinal central axis, causing the X-axis moving table 6 to slidingly move along the X-axis guide rails 12 in the X-axis direction.

A support table (chuck table) 8 for holding under suction the plate-shaped workpiece 11 is attached to an upper surface of the X-axis moving table 6. The support table 8 is coupled to a rotary actuator such as a motor (not illustrated) and is rotatable about a rotational axis vertical to an upper surface of the support table 8. In addition, the support table 8 is fed in the X-axis direction by the X-axis direction moving mechanism described above. The support table 8 has a front surface (upper surface) acting as a holding surface 8a for holding the plate-shaped workpiece 11 under suction thereon. The holding surface 8a of the support table 8 is fluidly connected to an unillustrated suction source, through an unillustrated fluid channel defined in the support table 8. Clamps 10 for fixing the annular frame 17 that holds the plate-shaped workpiece 11 via the sheet 19 are disposed around the holding surface 8a.

On an upper surface of the base 4, there is disposed a support structure 22 which supports two cutting units (processing units) 18 cutting the plate-shaped workpiece 11, in such a manner as to straddle the X-axis direction moving mechanism. On a front upper surface of the support structure 22, there is provided a cutting unit moving mechanism which moves the two cutting units 18 in a Y-axis direction (index feed direction) and a Z-axis direction.

This cutting unit moving mechanism has a pair of Y-axis guide rails 24 that are fixed to a front surface of the support structure 22 and are parallel to the Y-axis direction. Two Y-axis moving plates 26 corresponding to the respective cutting units 18 are slidably attached to the Y-axis guide rails 24. In addition, a nut portion (not illustrated) is provided on a back surface of the Y-axis moving plate 26, and a Y-axis ball screw 28 parallel to the Y-axis guide rails 24 is screwed into this nut portion. The Y-axis ball screw 28 has an axial end coupled to a Y-axis stepping motor 28a. When the Y-axis stepping motor 28a is energized, it rotates the Y-axis ball screw 28 about its longitudinal central axis, causing the Y-axis moving plate 26 to slidably move along the Y-axis guide rails 24 in the Y-axis direction. On a front surface (face side) of the Y-axis moving plate 26, there are provided a pair of Z-axis guide rails 30 parallel to the Z-axis direction. A Z-axis moving plate 32 is slidably attached to the pair of Z-axis guide rails 30.

In addition, a nut portion (not illustrated) is provided on a back surface (rear side) of the Z-axis moving plate 32, and a Z-axis ball screw 34 parallel to the Z-axis guide rails 30 is screwed into this nut portion. The Z-axis ball screw 34 has an axial end coupled to a Z-axis stepping motor 36. When the Z-axis stepping motor 36 is energized, it rotates the Z-axis ball screw 34, causing the Z-axis moving plate 32 to move along the Z-axis guide rails 30 in the Z-axis direction (cutting feed direction). The cutting unit 18 cutting the plate-shaped workpiece 11 and an imaging camera 38 imaging the plate-shaped workpiece 11 held on the support table 8 are fixed to each of the lower portions of the two Z-axis moving plates 32. As described below, the imaging camera 38 can function as a distance measuring unit.

When the Y-axis moving plate 26 is moved in the Y-axis direction, the cutting unit 18 and the imaging camera (distance measuring unit) 38 move in the Y-axis direction (index feed direction), and when the Z-axis moving plate 32 is moved in the Z-axis direction, the cutting unit 18 and the imaging camera 38 move in the Z-axis direction (cutting feed direction).

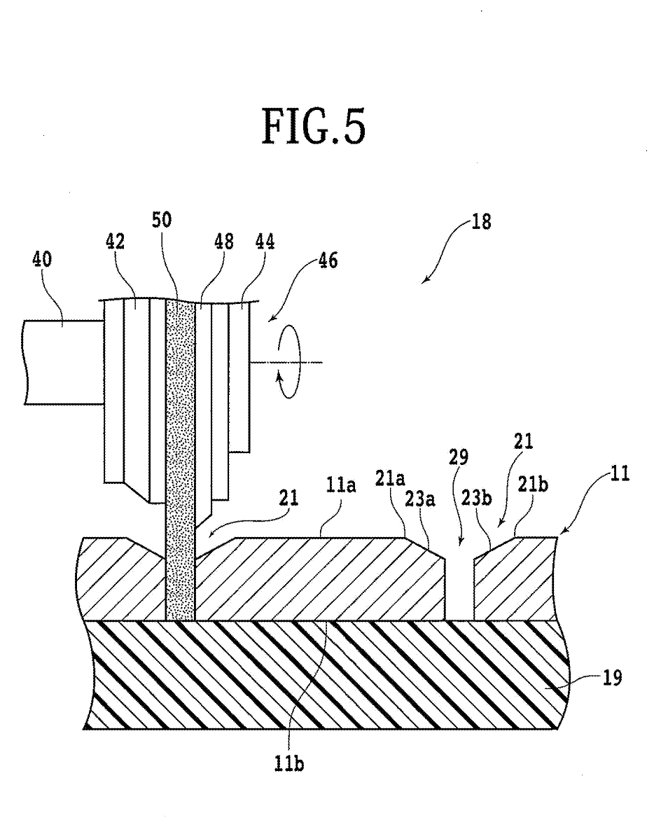

FIG. 5 is a side view partly illustrating the cutting unit 18. The cutting unit 18 has a horizontal spindle 40 having a longitudinal axis parallel to the Y-axis direction. A blade mount 42 is attached to a distal end of the spindle 40, and a cutting blade 46 in an annular ring shape is mounted to the distal end of the spindle 40 via the blade mount 42 by a nut 44. The spindle 40 has a proximal end portion coupled to an unillustrated rotary actuator such as an electric motor housed in a spindle housing 52 (see FIG. 3). When the rotary actuator is energized, it rotates the spindle 40 and hence the cutting blade 46 attached to the spindle 40 about their common central axis.

The cutting blade 46 includes, for example, a disc-shaped annular base 48 and an annular ring-shaped segment portion 50 provided to an outer circumferential portion of the annular base 48. The annular base 48 has an attachment hole in a substantially circular shape provided at its center, the attachment hole penetrating this annular base 48. When the cutting blade 46 is mounted to the cutting unit 18, a boss portion of the blade mount 42 attached to the spindle 40 is inserted through this attachment hole. The segment portion 50 of the cutting blade 46 includes a binder formed of metal or resin, for example, and a plurality of abrasive grains made of diamond, for example, fixed to the binder, and is also referred to as a cutting edge. An outer circumferential surface of the segment portion 50 of the cutting blade 46 which divides the plate-shaped workpiece 11 has a cylindrical shape. The abrasive grains are exposed from the binder. The cutting blade 46 is made to cut into the plate-shaped workpiece 11 while being rotated, and the exposed abrasive grains come into contact with the plate-shaped workpiece 11, so that the plate-shaped workpiece 11 is cut.

When the plate-shaped workpiece 11 is cut and divided, a height of the cutting unit 18 is adjusted such that a lower end of the segment portion 50 of the cutting blade 46 reaches lower than a lower surface (the back surface 11b) of the plate-shaped workpiece 11. In this case, the segment portion 50 of the cutting blade 46 reaches the sheet 19 disposed on the back surface 11b of the plate-shaped workpiece 11. Note that, in a case in which grooves not reaching the back surface 11b of the plate-shaped workpiece 11 are formed, the height of the cutting unit 18 is adjusted such that the lower end of the segment portion 50 is positioned at a height that is between the front surface 11a and the back surface 11b of the plate-shaped workpiece 11.

When the plate-shaped workpiece 11 is cut with the cutting blade 46, first, the plate-shaped workpiece 11 is placed on the holding surface 8a of the support table (chuck table) 8 and supported (held under suction) on the support table 8. Next, by causing the support table 8 to rotate about a rotary axis crossing the holding surface 8a, an orientation of a corresponding one of the dividing lines 13 is adjusted to the processing feed direction (X-axis direction).

Note that the orientation and the position of the dividing lines 13 set on the plate-shaped workpiece 11 are detected by imaging the front surface 11a of the plate-shaped workpiece 11 with the imaging camera 38. At this time, the shape, the position, and the like of the groove 21 formed in the dividing line 13 may also be detected and calculated with use of the imaging camera 38. However, a timing at which the shape, the position, and the like of the groove 21 are detected and calculated is not limited to this. For example, after the plate-shaped workpiece 11 is cut and a dividing groove 29 (see FIG. 5) is formed, the shape, the position, and the like of the groove 21 may be detected. Here, detection and calculation of the shape, the position, and the like of the groove 21 are not limited to acquisition of complete information with which the shape, the position, and the like of the groove 21 in the plate-shaped workpiece 11 can be uniquely identified, and detection and calculation of at least one of pieces of information related to the shape, the position, and the like of the groove 21 are also included. For example, detection and calculation of the shape, the position, and the like of the groove 21 may include detection and calculation of the shape, the position, and the like of the groove bottom portion 25 of the groove 21 and the shape, the position, and the like of the end portions 21a and 21b. Further, detection and calculation of the shape, the position, and the like of the groove 21 may include detection and calculation of an inclination angle of the first side portion 23a and the second side portion 23b and the length of the groove 21 in the width direction. Detailed description will be given later.

In addition, the relative position of the support table 8 and the cutting unit 18 is adjusted such that the segment portion 50 of the cutting blade 46 is disposed above an extension of the dividing line 13 (groove 21) outside the plate-shaped workpiece 11. Then, the spindle 40 is rotated, thereby rotating the cutting blade 46 at a rotational speed of approximately 30,000 revolutions per minute, and the height of the cutting unit 18 is adjusted such that the lower end of the segment portion 50 is lower than the lower surface (back surface 11b) of the plate-shaped workpiece 11. Then, the cutting unit 18 and the support table 8 are moved along the processing feed direction (the X-axis direction). That is, processing feeding is performed. Then, the segment portion 50 of the rotating cutting blade 46 comes into contact with the plate-shaped workpiece 11, and a dividing groove 29 along the dividing line 13 is formed in the plate-shaped workpiece 11. When the plate-shaped workpiece 11 is cut along all of the dividing lines 13, the plate-shaped workpiece 11 is divided, so that individual chips are manufactured.

Referring back to FIG. 3, the cutting apparatus (the detecting apparatus, or the calculating apparatus) 2 will be described. The cutting apparatus 2 further includes a controller or control unit 54. The controller 54 has a function for controlling the various components of the cutting apparatus 2, such as the cutting unit 18, the support table (chuck table) 8, the moving mechanisms, and the imaging camera 38. For example, the controller 54 includes a computer. Specifically, the controller 54 includes a processing unit for carrying out processing operations such as arithmetic operations required to operate the cutting apparatus (the detecting apparatus, or the calculating apparatus) 2 and a storage unit for storing various pieces of information such as data and programs that are used to operate the cutting apparatus 2. The processing unit includes a processor such as a central processing unit (CPU). In addition, the storing unit includes a memory such as a read only memory (ROM) or a random access memory (RAM).

Also, as illustrated in FIG. 3, the cutting apparatus 2 has a display unit 56. The display unit 56 is electrically connected to the controller 54, and as a result of cutting processing, displays various types of warning messages and the like. The display unit 56 may be a display panel with a touch panel. In this case, a user or an operator of the cutting apparatus 2 can use the touch panel to input information such as processing conditions to the controller 54. In addition, on the upper portion of the cutting apparatus 2, a warning lamp 58 electrically connected to the controller 54 is disposed. The controller 54 turns on the warning lamp 58 in green, for example, when the cutting apparatus 2 is operating normally, thereby notifying the user or the operator that the cutting apparatus 2 is operating normally. Conversely, when some problem has occurred in the cutting apparatus 2, the controller 54 turns on the warning lamp 58 in red, thereby notifying the user or the operator of that respect.

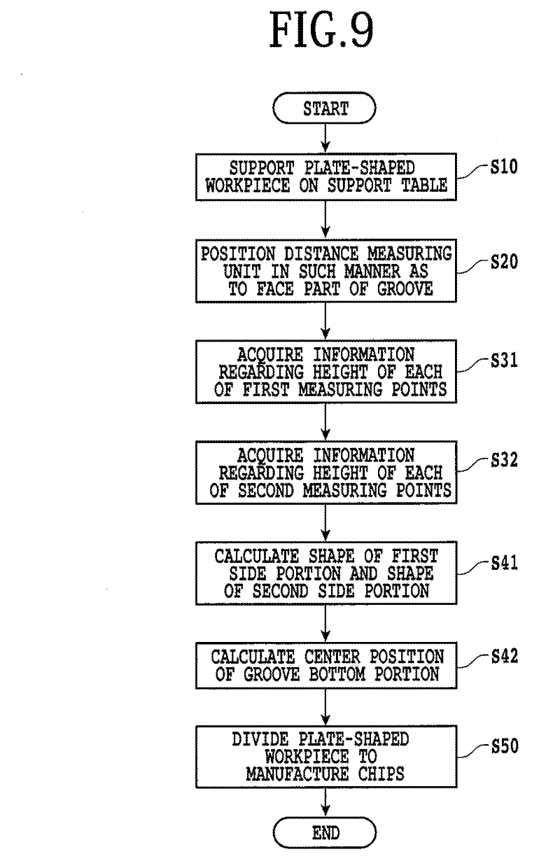

Next, a chip manufacturing method by which the cutting apparatus (the detecting apparatus, or the calculating apparatus) 2 is used to form the dividing grooves in the plate-shaped workpiece 11 formed with the grooves 21 therein and divide the plate-shaped workpiece 11 into individual chips will be described. The chip manufacturing method to be described below includes a processing step of a calculating method (detecting method) of a shape of the groove 21 formed in the plate-shaped workpiece 11 (for example, a center position of the groove bottom portion 25 of the groove 21). FIG. 9 is a flowchart illustrating a flow of steps of the method of dividing the plate-shaped workpiece 11 and manufacturing chips. In the chip manufacturing method to be described below, the plate-shaped workpiece 11 described above is divided into individual chips, so that the chips are manufactured. More specifically, the plurality of dividing lines 13 are set along the front surface 11a, and the plate-shaped workpiece 11 formed with the V-shaped grooves 21 along the dividing lines 13 is divided. The grooves 21 each has the groove bottom portion 25 extending along the longitudinal direction of the groove 21, the first side portion 23a formed in a region extending from the one end portion 21a of the groove 21 in the width direction to the groove bottom portion 25, and the second side portion 23b formed in a region extending from the other end portion 21b of the groove 21 in the width direction to the groove bottom portion 25.

Moreover, in the chip manufacturing method described below, the imaging camera 38 is used as a distance measuring unit. The distance measuring unit has a function of measuring a distance from the distance measuring unit to a predetermined measurement point. The imaging camera 38 can adjust, by the cutting unit moving mechanism described above, the height (the position in the Z-axis direction) relative to the plate-shaped workpiece 11 supported by the support table 8. In addition, the cutting unit moving mechanism may move the measurement point of the distance measuring unit along the Y-axis direction and the like (the width direction of the groove 21, for example). The imaging camera 38 has a focused point at a position apart by a predetermined distance, for example, and is focused on an object that is present at the position apart by this predetermined distance. In other words, it should be understood that the object on which the imaging camera 38 is focused when the object is imaged by the imaging camera 38 is an object that is apart from the imaging camera 38 by the predetermined distance. Specifically, the imaging camera 38 is focused at a specific position (measurement point), so that this specific position is determined to be apart from the imaging camera 38 by the predetermined distance. Thus, according to the height position of the imaging camera 38 when the imaging camera 38 is focused on the specific position, the height of the specific position can be measured.

However, an operation mode of the imaging camera 38 functioning as the distance measuring unit is not limited to this. For example, the imaging camera 38 may change a focus distance. In this case, when imaging the specific position (measurement point), the imaging camera 38 changes the focus distance, and according to the focus distance when a focus is adjusted, the distance from the imaging camera 38 to the specific position can be measured. Specifically, the height of this specific position (measurement point) in the plate-shaped workpiece 11 can be identified. Note that the distance measuring unit is not limited to the imaging camera 38. The distance measuring unit may be a laser rangefinder which irradiates, for example, the measurement point with a laser beam and receives its reflected light, to thereby identify the distance to the measurement point. Alternatively, the distance measuring unit may be an ultrasonic rangefinder which irradiates the measurement point with an ultrasonic wave and receives its reflected wave, to thereby identify the distance to the measurement point. However, the distance measuring unit is not limited to such examples. In the following description, an example in which the distance measuring unit is the imaging camera 38 will be described.

In the chip manufacturing method by which the chips are manufactured from the plate-shaped workpiece 11 formed with the grooves 21 (the calculating method of calculating the center position of the groove bottom portion 25 of the groove 21), first, the plate-shaped workpiece 11 is supported by the support table (chuck table) 8 (S10). Specifically, the plate-shaped workpiece 11 is held under suction on the support table 8. As illustrated in FIG. 3, the plate-shaped workpiece 11 supported by the support table 8 may be integrated with the sheet 19 and the frame 17 in advance. In this case, the plate-shaped workpiece 11 is held under suction by the support table 8, with the sheet 19 interposed therebetween.

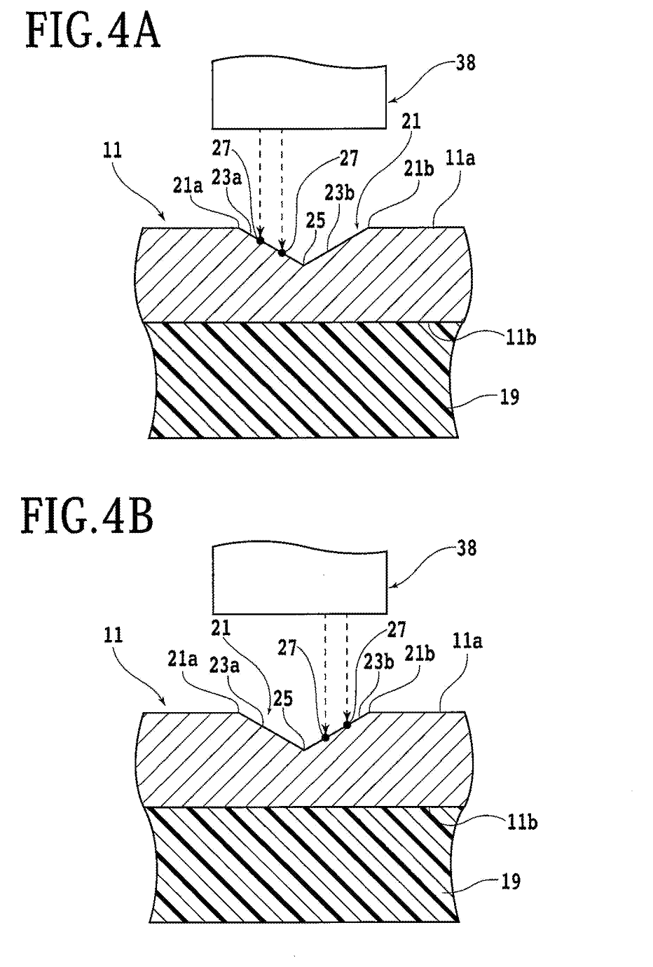

Next, in such a manner as to face part of the groove 21 of the plate-shaped workpiece 11, the imaging camera (distance measuring unit) 38 is positioned (S20). At this time, one of or both the support table 8 which supports the plate-shaped workpiece 11 and the imaging camera 38 is/are moved. In addition, by rotating the support table 8 at this time, the orientation of the plate-shaped workpiece 11 may be adjusted such that the dividing lines 13 (grooves 21) face a predetermined orientation. FIG. 4A and FIG. 4B illustrate the imaging camera 38 whose position is adjusted in such a manner as to face the part of the groove 21 of the plate-shaped workpiece 11. Note that, among the grooves 21 formed in the plate-shaped workpiece 11, some of the grooves 21 which face the imaging camera 38 do not have any particular limitations. As described below, since the predetermined measurement point inside the groove 21 is captured by the imaging camera 38, the part of the groove 21 may preferably be close to the measurement point. In addition, when the imaging camera (distance measuring unit) 38 is positioned in such a manner as to face the part of the groove 21 of the plate-shaped workpiece 11, the whole region of the groove 21 may be included within the field of view of the imaging camera 38.

Next, regarding each of two or more of first measurement points 27 set on the first side portion 23a of the groove 21 such that the positions of the relevant first measurement points 27 in the grooves 21 in the width direction are different from each other, information regarding the height of each of the first measurement points 27 is acquired with use of the distance measuring unit (imaging camera 38) (S31). Then, the shape of the first side portion 23a is calculated (S41). For example, the height means the position in the Z-axis direction. FIG. 4A is a cross-sectional view schematically illustrating the manner in which, at each of the first measurement points 27 set to the first side portion 23a, information regarding the height of each of the first measurement points 27 is acquired, with use of the distance measuring unit (imaging camera 38).

In this case, the information regarding the height acquired at each of the first measurement points 27 is referred to as, for example, a relative height of each point with respect to the height of the front surface 11a or the back surface 11b of the plate-shaped workpiece 11. In other words, it is referred to as a relative height of each point with respect to the height of the holding surface 8a that is the upper surface of the support table 8. Alternatively, it is referred to as a distance between the distance measuring unit (imaging camera 38) and each of the first measurement points 27. Further, as an alternative, it is referred to as a distance between the distance measuring unit (imaging camera 38) and each of the first measurement points 27 in the Z-axis direction. However, the information regarding the height is not limited to such examples.

Also, here, the setting of the first measurement points 27 at which the information regarding the height thereof is acquired may be performed on the basis of the position of the groove 21 (first side portion 23a) which is identified in the plate-shaped workpiece 11 (dividing lines 13). More specifically, the groove 21 formed in the plate-shaped workpiece 11 is imaged by the imaging camera 38, and the position of the groove 21 is identified with low accuracy. Then, with reference to this position of the groove 21, two or more of the first measurement points 27 may be set to the first side portion 23a.

Also, setting of the first measurement points 27 may be performed by acquiring information regarding a height of each of a plurality of positions of the first measurement points 27 on an upper surface (front surface 11a) of the plate-shaped workpiece 11 with use of the distance measuring unit (imaging camera 38) and selecting one of the plurality of positions thereof with reference to the result thus acquired. In this case, it is considered that a group evaluated that the height is equivalent among the plurality of positions belongs to an outside of the groove 21. In contrast, it is considered that other positions being located lower than the plurality of positions belonging to the group belong to an inner surface of the groove 21. Particularly, among such positions, in a case in which two adjacent positions are different in height, it is considered that any one of them may belong to the first side portion 23a of the groove 21, and accordingly, these positions are considered to be selected as the first measurement points 27. In this manner, a tendency regarding the height position of each position may be detected in advance, and the first measurement point 27 may be set retrospectively.

Note that, in a case in which information regarding the height is acquired at each of a plurality of points (measurement points) that are apart from each other at an equal interval in the width direction of the groove 21, this interval may be determined according to a value of the width of the groove 21. Specifically, this interval may preferably be smaller than half the width of the groove 21. In a case in which this interval, that is, a distance between adjacent ones of the measurement points in the width direction, is equal to or more than half the width of the groove 21, two or more of the first measurement points 27 cannot be set on the first side portion 23a of the groove 21. Moreover, the distance between adjacent ones of the measurement points in the width direction is preferably smaller than one-third the width of the groove 21. As described below, in a case in which two first measurement points 27 are set on the first side portion 23a and two second measurement points 27 are set on the second side portion 23b, when this distance (interval) between adjacent ones of each of the first and second measurement points in the width direction is equal to or more than one-third the width of the groove 21, measurement points cannot be set on the first side portion 23a and the second side portion 23b.

When information regarding the height of each of the plurality of first measurement points 27 is acquired, an inclined angle of an inclined surface constituting the first side portion 23a, a position of the inclined surface, and the like can be calculated according to each position of the first measurement points 27 on a plane (XY plane) parallel to the front surface 11a of the plate-shaped workpiece 11. In other words, the inclined surface including the plurality of first measurement points 27 is derived as the first side portion 23a. In this manner, information regarding the shape of the first side portion 23a and the position of the first side portion 23a of the groove 21 is calculated. However, all elements regarding the shape of the first side portion 23a may not be calculated at this time. For example, the position of the terminal end of the first side portion 23a, that is, the position of the groove bottom portion 25, may not be identified.

According to the processing step similar to the calculation of the shape of the first side portion 23a, the shape of the second side portion 23b is calculated. More specifically, regarding each of two or more of the second measurement points 27 set on the second side portion 23b of the groove 21 such that the positions of the second measurement points 27 in the groove 21 in the width direction are different from each other, the information regarding the height of each of the second measurement points 27 is acquired with use of the distance measuring unit (imaging camera 38) (S32). Then, the shape of the second side portion 23b is calculated (S41). FIG. 4B is a cross-sectional view schematically illustrating the manner in which, regarding the second measurement points 27 set on the second side portion 23b, the information regarding the height of each of the second measurement points 27 is acquired with use of the distance measuring unit (imaging camera 38).

Note that the abovementioned description related to acquisition of information regarding the height of each of the first measurement points 27 set on the first side portion 23a can be referred to as description related to acquisition of the information regarding the height of each of the second measurement points 27 set on the second side portion 23b, as needed. In addition, the abovementioned description related to the calculation of the shape of the first side portion 23a can be referred to as description related to the calculation of the shape of the second side portion 23b, as needed. Moreover, either the acquisition of the information regarding the height of each of the first measurement points 27 or the acquisition of the information regarding the height of each of the second measurement points 27 may be performed first, or they may be performed at the same time. Further, either the calculation of the shape of the first side portion 23a or the calculation of the shape of the second side portion 23b may be performed first, or they may be performed at the same time. For example, they may be performed by the controller 54 of the cutting apparatus (detecting apparatus) 2.

In the chip manufacturing method for chips to be manufactured from the plate-shaped workpiece 11, next, according to the shape of the first side portion 23a and the shape of the second side portion 23b, the center position of the groove bottom portion 25 is calculated (S42). Here, the groove bottom portion 25 signifies a region sandwiched by the first side portion 23a and the second side portion 23b of the inner surface of the groove 21. Further, the center position of the groove bottom portion 25 signifies the position of the center of the groove bottom portion 25 of the groove 21 in the width direction. In particular, the position in a plane parallel to the front surface 11a of the plate-shaped workpiece 11 at the center of the groove bottom portion 25 is desirably calculated.

Note that, in a case in which the interval between the first side portion 23a and the second side portion 23b is significantly small and the width of the groove bottom portion 25 does not have a substantial width, that is, the groove 21 is a V-shaped groove, the groove bottom portion 25 provides a linear region. In this case, the center position of the groove bottom portion 25 is substantially equivalent to the position of the groove bottom portion 25. Note that detailed description regarding the calculating step of the center position of the groove bottom portion 25 in a case in which the groove 21 formed in the plate-shaped workpiece 11 is not in a V-shape will be given later. In a case in which the groove 21 is a V-shaped groove, the center position of the groove bottom portion 25 is the position of a straight line where an inclined surface constituting the first side portion 23a and an inclined surface constituting the second side portion 23b cross each other. Hence, according to the shape of the first side portion 23a and the shape of the second side portion 23b, the position of the straight line (intersection line) formed by both the inclined surfaces crossing each other is calculated. At this time, pieces of information regarding the shape of the first side portion 23a and the shape of the second side portion 23b, and the like, may be referred to.

Next, with reference to the calculated center position of the groove bottom portion 25, dividing grooves are formed along the dividing lines 13 in the plate-shaped workpiece 11, and the plate-shaped workpiece 11 is divided into individual pieces to manufacture chips (S50). FIG. 5 is a cross-sectional view schematically illustrating the manner in which the plate-shaped workpiece 11 is cut and divided by way of example. Cutting of the plate-shaped workpiece 11 is performed by the cutting unit 18.

When the plate-shaped workpiece 11 is cut, the segment portion 50 of the cutting blade 46 is positioned above an extension line of a corresponding one of the dividing lines 13. At this time, with reference to the calculated center position of the groove bottom portion 25, in such a manner that the center position of the groove bottom portion 25 of the groove 21 and the center of the segment portion 50 in the thickness direction are arranged in the processing feed direction (X-axis direction), the position of the cutting unit 18 relative to the support table 8 is adjusted. After that, the height of the cutting unit 18 is adjusted such that the lower end of the segment portion 50 is lower than the lower surface (back surface 11b) of the plate-shaped workpiece 11, and while the cutting blade 46 is rotated at high speed, the cutting unit 18 and the support table 8 are processing-fed relative to each other (moved along the X-axis direction). Consequently, the plate-shaped workpiece 11 is cut, and the dividing groove 29 is formed in the plate-shaped workpiece 11. The sheet 19 is exposed at the groove bottom portion 31 of the dividing groove 29.

After the dividing groove 29 is similarly formed in the plate-shaped workpiece 11 along another one of the dividing lines 13, the cutting unit 18 and the like are index-fed (moved along the Y-axis direction), and the plate-shaped workpiece 11 is similarly cut along the corresponding one of the other dividing lines 13 to form the dividing groove 29. After the plate-shaped workpiece 11 is cut, index-feeding of the cutting unit 18 and the like is performed by a predetermined amount determined on the basis of the interval of adjacent ones of the dividing lines 13, and then, the center of the segment portion 50 in the thickness direction and the center position of the groove bottom portion 25 are arranged in the X-axis direction also when the plate-shaped workpiece 11 is next cut. Accordingly, an amount of index-feeding may be a predetermined amount determined on the basis of the interval of the adjacent ones of the dividing lines 13, and at this time, there is no need that the center position of the groove bottom portion 25 is referred to. In other words, when one plate-shaped workpiece 11 is cut and divided, it may be sufficient if calculation of the center position of the groove bottom portion 25 of the groove 21 is performed once. Further, in other words, there is no need that calculation of the center position of the groove bottom portion 25 of the groove 21 is performed on all the grooves 21 formed in the plate-shaped workpiece 11.

When the plate-shaped workpiece 11 is cut and the grooves 29 are formed along all of the dividing lines 13, the plate-shaped workpiece 11 is divided into individual chips, whereby the chips are manufactured. In this case, in a case in which the plate-shaped workpiece 11 is preliminarily formed with the groove 21 and the dividing groove 29 is formed inside the groove 21, an inclined surface attributable to the groove 21 (the first side portion 23a and the second side portion 23b) appears at the end portion of the chip. That is, the end portion of the chip is chamfered. Accordingly, a crack or chipping of the chip manufactured is less likely to occur. In addition, in a case in which the plate-shaped workpiece 11 is divided in a state in which a positional relation between the center of the segment portion 50 in the thickness direction and the center position of the groove bottom portion 25 is adjusted, the segment portion 50 receives a force acting on the reaction equally by the first side portion 23a and the second side portion 23b of the groove 21. As a result, a large bending force is not applied to the cutting blade 46 (segment portion 50), and the plate-shaped workpiece 11 can be subjected to full cutting, so that the quality of the dividing groove 29 formed becomes higher.

Note that dividing of the plate-shaped workpiece 11 is not necessarily performed in the cutting apparatus 2, and the cutting apparatus 2 may simply perform only calculation of the center position of the groove bottom portion 25 of the groove 21, or the plate-shaped workpiece 11 may not be cut. In other words, calculation of the center position of the groove bottom portion 25 of the groove 21 may be performed in an inspection apparatus not provided with the cutting unit 18.

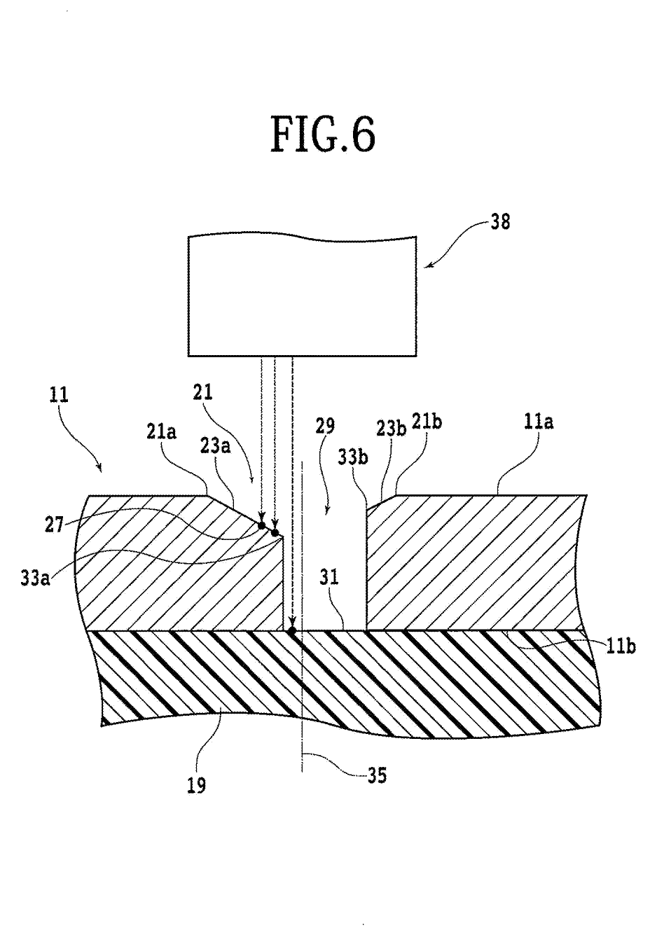

Although description regarding determination of the position of the cutting blade 46 with reference to the calculated center position of the groove bottom portion 25 of the groove 21 has been given so far, the calculated center position of the groove bottom portion 25 of the groove 21 can also be used for other purposes. For example, it is also possible to use the calculated center position of the groove bottom portion 25 of the groove 21 for determination as to whether or not the position of the dividing groove 29 formed in the plate-shaped workpiece 11 is appropriate. Next, the step of determining whether or not the position of the dividing groove 29 formed in the plate-shaped workpiece 11 is appropriate will be described. Also in a case in which a determination as to whether or not the position of the dividing groove 29 is appropriate is made, first, the plate-shaped workpiece 11 is supported by the support table (chuck table) 8 (S10), the distance measuring unit (imaging camera 38) is positioned in such a manner as to face part of the groove 21 of the plate-shaped workpiece 11 (part of the dividing groove 29) (S20). After that, each measurement point is set on the inner surface of the groove 21 (dividing groove 29), and information regarding the height of each of the measurement points is acquired (S31 and S32). FIG. 6 is a cross-sectional view schematically illustrating the manner in which information regarding the height of each of the measurement points is acquired in the plate-shaped workpiece 11 in which the dividing grooves 29 are formed in the groove 21. In particular, FIG. 6 illustrates a case in which the measurement points 27 are set on the first side portion 23a and the like of the groove 21 and information regarding the height of each of the measurement points 27 is acquired.

In a case in which the dividing groove 29 is formed in the groove 21, that is, in a case in which the plate-shaped workpiece 11 is subjected to full cutting, the measurement point 27 may be set on the first side portion 23a or the second side portion 23b remaining in the groove 21. Alternatively, the measurement point 27 may be set on the groove bottom portion 31 of the dividing groove 29 formed in the groove 21. Further, the height of the measurement point 27 in a case in which the relevant measurement point 27 is set on the groove bottom portion 31 of the dividing groove 29 is significantly lower than the height of the measurement point 27 in a case in which the measurement point 27 is set on the first side portion 23a or the second side portion 23b. Accordingly, a boundary 33a between the first side portion 23a and the dividing groove 29 and a boundary 33b between the second side portion 23b and the dividing groove 29 are each disposed between two adjacent measurement points 27 which are greatly different in height among a plurality of successive measurement points 27.

In this manner, information regarding the height of each of two or more of the measurement points set in the dividing groove 29 such that the positions of the relevant measurement points in the width direction of the dividing grooves 29 are different from each other is acquired with use of the distance measuring unit (imaging camera 38). Accordingly, the position of the boundary 33a between the first side portion 23a and the dividing groove 29 and the position of the boundary 33b between the second side portion 23b and the dividing groove 29 can be calculated. Then, after the positions of the boundaries 33a and 33b are identified, it is possible to detect the formation position of the dividing groove 29. In other words, the shape of the dividing groove 29 can be calculated.

In addition, the information regarding the height of each of the measurement points 27 set on the first side portion 23a or the second side portion 23b remaining in the groove 21 is acquired, so that the shape of each of the first side portion 23a and the second side portion 23b can be calculated (S41). Then, according to the calculated shape of each of the first side portion 23a and the second side portion 23b, a center position 35 of the groove bottom portion 25 of the groove 21 prior to formation of the dividing groove 29 can be calculated (S42).

In general, in a case in which the center of the segment portion 50 of the cutting blade 46 in the thickness direction, the cutting blade 46 having been used in formation of the dividing groove 29, is appropriately aligned with the center position 35 of the groove bottom portion 25 of the groove 21 in the X-axis direction, the calculated center of the dividing groove 29 should be matched with the center position 35 of the groove bottom portion 25 of the groove 21. In other words, it has been checked that, in a case in which the calculated center of the dividing groove 29 and the center position 35 of the groove bottom portion 25 of the groove 21 are matched with each other (are overlapped with each other in the Z-axis direction), the cutting blade 46 has appropriately been aligned and positioned at a predetermined position.

Meanwhile, it has been checked that, in a case in which the calculated center of the dividing groove 29 and the center position 35 of the groove bottom portion 25 of the groove 21 are not matched with each other (are not overlapped with each other in the Z-axis direction), the cutting blade 46 has not been positioned at the predetermined position. In this case, according to a shift amount of the center of the dividing groove 29 and the center position 35 of the groove bottom portion 25 of the groove 21, the position of the cutting unit 18 is adjusted, so that the cutting apparatus 2 can appropriately perform cutting thereafter.

In the past, whether or not the region to be subjected to cutting with the cutting blade 46 in the cutting apparatus 2 has been performed by a method called half-kerf checking. In this half-kerf checking, before the dividing line 13 is subjected to full cutting by the cutting blade 46, the end portion of the dividing line 13 of the plate-shaped workpiece 11 is cut by the cutting blade 46. At this time, the plate-shaped workpiece 11 is not subjected to full cutting, and a half-cut groove having a groove bottom portion at a height position between the front surface 11a and the back surface 11b is formed in the plate-shaped workpiece 11. Also, this formation position of the groove for half-kerf check, and the like, is checked, and accordingly, whether or not the position of the cutting blade 46, and the like, are appropriate has been checked. However, in this method, the segment portion 50 of the cutting blade 46 comes in contact with a wiring layer, a function layer, a test element group (TEG), and the like which are formed on the front surface 11a of the plate-shaped workpiece 11, thereby causing wearing of the segment portion 50. Moreover, the plate-shaped workpiece 11 needs to be cut only for half-kerf check, thereby requiring a non-negligible amount of effort.

In contrast, in the chip manufacturing method according to the present embodiment, in order to form chips, calculation of the shape of the dividing groove 29 formed in the plate-shaped workpiece 11 makes it possible to check whether or not alignment of the cutting blade 46 has been done favorably, thereby requiring little effort. In addition, the segment portion 50 of the cutting blade 46 cuts in the groove 21 which is formed in the plate-shaped workpiece 11 in advance. In this groove 21, the wiring layer and the like formed on the front surface 11a of the plate-shaped workpiece 11 are removed, and accordingly, significant wear may not be caused in the segment portion 50 in association with checking as to whether or not alignment of the cutting blade 46 has been done favorably.

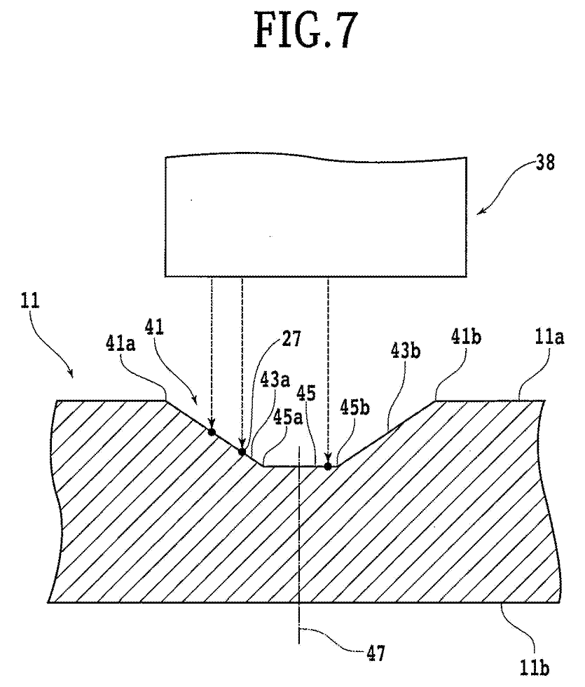

Taking an example as a case in which the groove 21 formed in the plate-shaped workpiece 11 in advance is in a V-shape, the calculating method of calculating the center position of the groove bottom portion 25 of the groove 21, and the like, have been described so far. However, the shape of the groove 21 is not limited to the V-shape. Hereinafter, a case in which grooves having a shape other than the V shape are formed in the plate-shaped workpiece 11 will be described. FIG. 7 is a cross-sectional view schematically illustrating the manner in which the information regarding the height of each of the measurement points is acquired in a case in which a groove 41 having an inverted trapezoidal cross section (an upside-down trapezoid, or a trapezoid whose lower base is smaller than its upper base) is formed in the plate-shaped workpiece 11. Next, a calculating method for the shape of the groove 41 (a calculating method for the center position of the groove bottom portion) in a case in which the groove 41 having an inverted trapezoidal cross section is formed in the plate-shaped workpiece 11 will be described.

First, the groove 41 having an inverted trapezoidal cross section is formed by cutting the plate-shaped workpiece 11 along each of the dividing lines 13 with a cutting blade. An outer circumferential surface of a segment portion of the cutting blade to be used at this time protrudes in a trapezoidal shape. The groove 41 illustrated in FIG. 7 has a groove bottom portion 45 extending along the longitudinal direction of the groove 41 (X-axis direction). The groove 41 further has a first side portion 43a formed in a region extending from one end portion 41a of the groove 41 in the width direction (Y-axis direction) to the groove bottom portion 45 and a second side portion 43b formed in a region extending from the other end portion 41b of the groove 41 in the width direction to the groove bottom portion 45. The groove bottom portion 45 of the groove 41 has a predetermined width corresponding to the shape of the segment portion of the cutting blade, and is a plane parallel to the front surface 11a of the plate-shaped workpiece 11. The first side portion 43a and the second side portion 43b are each mainly formed of an inclined surface having the same width. An inclined angle (angle of depression) of the inclined surface constituting the first side portion 43a and an inclined angle (angle of elevation) of the inclined surface constituting the second side portion 43b are matched with each other.

In the calculating method (the calculating method of the center position of the groove bottom portion 45) for the shape of the groove 41 in the plate-shaped workpiece 11 formed with the inverted trapezoidal groove 41, first, the plate-shaped workpiece 11 is placed on the support table (chuck table) 8 and supported (held under suction) on the support table 8 (S10). Next, the distance measuring unit (imaging camera 38) is positioned in such a manner as to face part of the groove 41 (S20).

Then, information regarding the height of each of two or more of the first measurement points 27 set on the first side portion 43a of the groove 41 such that the positions of the first measurement points 27 in the groove 41 in the width direction are different from each other is acquired with use of the distance measuring unit (imaging camera 38) (S31), and the shape of the first side portion 43a is calculated (S41). At the same time, information regarding the height of each of two or more of the second measurement points 27 set on the second side portion 43b of the groove 41 such that the positions of the second measurement points 27 in the groove 41 in the width direction are different from each other is acquired with use of the distance measuring unit (imaging camera 38) (S32), and the shape of the second side portion 43b is calculated (S41).

More specifically, for example, a plurality of the measurement points 27 are set on an inner surface of the groove 41 (the first side portion 43a, the groove bottom portion 45, and the second side portion 43b) so as to be arranged from the end portion 41a of the groove 41 to the end portion 41b in the width direction of the groove 41. Then, the information regarding the height of each of the measurement points 27 is acquired with the distance measuring unit (imaging camera 38). At this time, according to the acquired information regarding the height of each of the measurement points 27, it is determined at which place on the inner surface of the groove 41 (the first side portion 43a, the groove bottom portion 45, or the second side portion 43b) the measurement point 27 is positioned. That is, each of the measurement points 27 is set retrospectively onto any of the first side portion 43a, the groove bottom portion 45, and the second side portion 43b. More specifically, for example, a plurality of measurement points 27 whose height successively decreases from the end portion 41a of the groove 41 belong to the first side portion 43a. Moreover, a plurality of measurement points 27 whose height is constant belong to the groove bottom portion 45. Further, a plurality of measurement points 27 whose height successively increases to the end portion 41b of the groove 41 belong to the second side portion 43b.

Accordingly, it is determined that a boundary 45a between the first side portion 43a and the groove bottom portion 45 is positioned between the measurement point 27 which is positioned on the first side portion 43a and which is closest to the groove bottom portion 45 and the measurement point 27 which is positioned on the groove bottom portion 45 and which is closest to the first side portion 43a. In addition, it is determined that a boundary 45b between the second side portion 43b and the groove bottom portion 45 is positioned between the measurement point 27 which is positioned on the second side portion 43b and which is closest to the groove bottom portion 45 and the measurement point 27 which is positioned on the groove bottom portion 45 and which is closest to the second side portion 43b. Hence, the shape of the groove 41 (the shapes and the positions of the first side portion 43a, the groove bottom portion 45, and the second side portion 43b) are calculated. However, the step of calculating the shape of the groove 41 is not limited to the above.

Next, according to the shape of the first side portion 43a and the shape of the second side portion 43b, a center position 47 of the groove bottom portion 45 of the groove 41 in the width direction is calculated (S42). For example, a position of an intersection line where the inclined surface constituting the first side portion 43a and the inclined surface constituting the second side portion 43b cross each other is calculated. The position of the intersection line in the width direction of the groove 41 is the center position 47 of the groove bottom portion 45 in the width direction. Alternatively, the position in the middle point between the measurement point 27 which is positioned on the groove bottom portion 45 and which is closest to the first side portion 43a and the measurement point 27 which is positioned on the groove bottom portion 45 and which is closest to the second side portion 43b may be calculated as the center position 47. In this manner, in the calculating method for the shape of the groove 41 (calculating method for the center position of the groove bottom portion) according to the present embodiment, the center position 47 of the groove bottom portion 45 of the groove 41 formed in the plate-shaped workpiece 11 can easily and highly accurately be calculated. Then, when the plate-shaped workpiece 11 is cut with the center of the groove bottom portion 45 being aligned with the center of the segment portion 50 of the cutting blade 46, a significant bending force is not applied to the cutting blade 46, and the plate-shaped workpiece 11 is subjected to full cutting, so that chips can be manufactured.

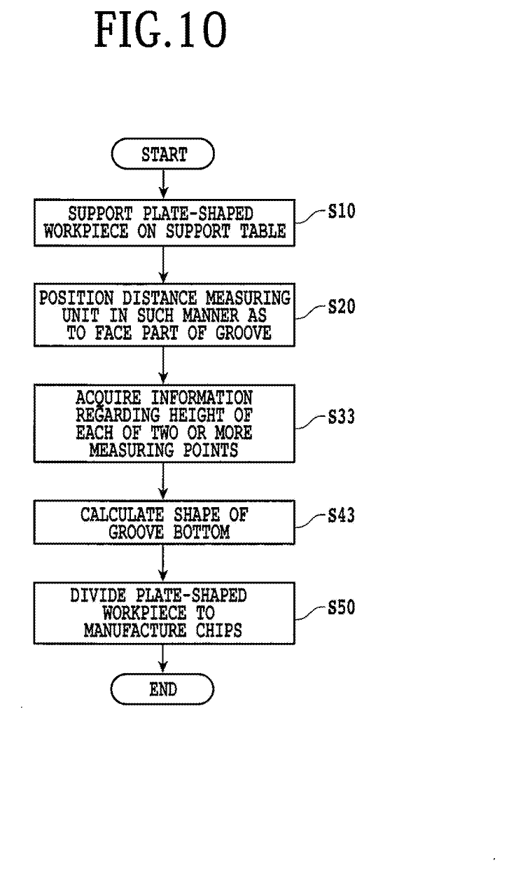

The present invention is not limited to the above description of the present embodiment, and various changes and modifications may be made in the embodiment. For example, in the embodiment above, a case in which the cross sections of the grooves 21 and 41 formed in the plate-shaped workpiece 11 are each symmetrical in the width direction has been described as an example. However, the groove formed in the plate-shaped workpiece 11 and the shape of which is calculated, for example, is not limited to this. Hereinafter, regarding a case in which the cross section of the groove formed in the plate-shaped workpiece 11 in advance is not symmetrical, the calculating method for the shape of the groove according to one mode of the present invention and the chip manufacturing method will be described. FIG. 10 is a flowchart illustrating another flow of steps of the chip manufacturing method in such a case. In the chip manufacturing method, the calculating method for the shape of the groove is performed. Hence, description of the chip manufacturing method below can be referred to as description of the calculating method for the shape of the groove, as needed.

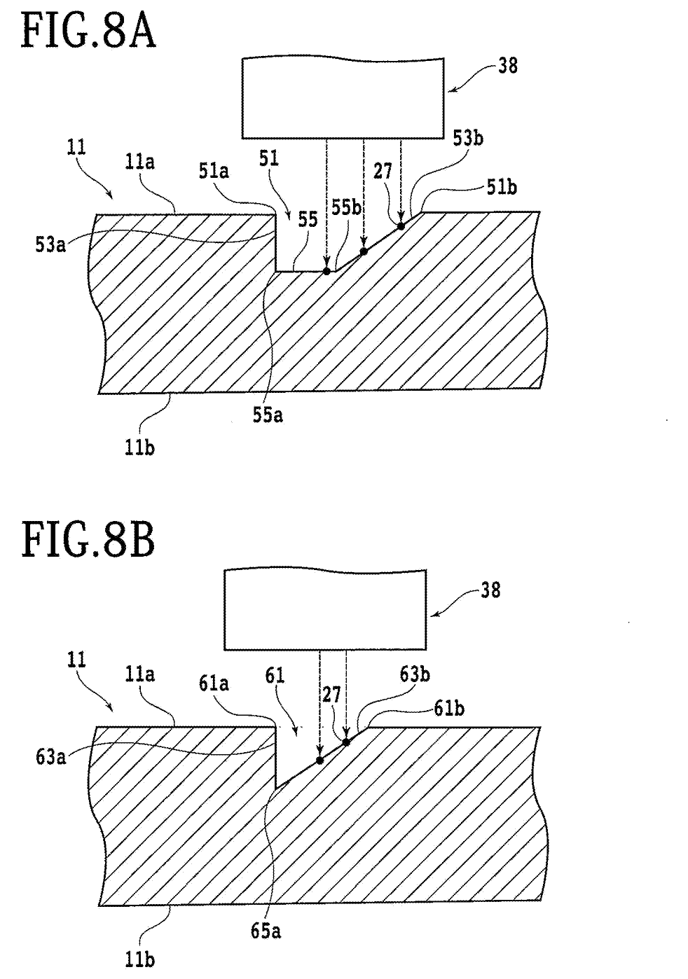

In the chip manufacturing method illustrated in FIG. 10 (the calculating method for the shape of the groove), for example, for the plate-shaped workpiece 11 where a groove 51 illustrated in FIG. 8A is formed along the dividing lines 13, the shape of the groove 51 is calculated. The groove 51 becomes steeper from one end portion 51a toward a groove bottom portion 55. As such, a first side portion 53a on this one end portion 51a side is vertical to the front surface 11a of the plate-shaped workpiece 11. In addition, the first side portion 53a is vertically connected to the groove bottom portion 55 at a boundary 55a between the groove bottom portion 55 and the first side portion 53a. The groove bottom portion 55 of the groove 51 is a plane that is parallel to the front surface 11a of the plate-shaped workpiece 11 and that has a predetermined width. A boundary 55b opposite to the boundary 55a of the groove bottom portion 55 is connected to a second side portion 53b. The second side portion 53b is an inclined surface which becomes steeper from the boundary 55b toward an end portion 51b. In this manner, the groove 51 illustrated in FIG. 8A is not symmetrical.

Also in this case, first, the plate-shaped workpiece 11 is supported (held under suction) on the support table (chuck table) 8 (S10), and the distance measuring unit (imaging camera 38) is positioned in such a manner as to face part of the groove 51 of the plate-shaped workpiece 11 (S20). Then, two or more of the measurement points 27 are set on the inner surface of the groove 51 such that the positions of the measurement points 27 in the width direction of the groove 51 are different from each other, and as illustrated in FIG. 8A, information regarding the height of each of the measurement points 27 is acquired with use of the distance measuring unit (imaging camera 38).

For example, in a case in which, according to the height positions of the plurality of measurement points 27, it is checked that the measurement points 27 are arranged on the inclined surface with a predetermined slope, it is understood that these measurement points 27 are set on the second side portion 53b. In addition, it is understood that, among the plurality of measurement points 27, the measurement point 27 that is adjacent to a point farthest from the end portion 51b of the groove 51 and that is not on the inclined surface constituting the second side portion 53b is set on the groove bottom portion 55. Also, in a case in which, according to the height positions of the plurality of measurement points 27, it is checked that these measurement points 27 are arranged on the plane parallel to the front surface 11a, it is understood that these measurement points 27 are set on the groove bottom portion 55. Moreover, in a case in which the height positions of the two adjacent measurement points 27 are greatly different from each other, it is understood that the vertical first side portion 53a is located between these two measurement points 27.

In this manner, according to the obtained information regarding the height of each of the measurement points 27, the shape of the groove 51 is calculated (S43). Note that, when the shape of the groove 51 is calculated, the center position of the groove bottom portion 55 in the width direction may also be calculated. Alternatively, when the shape of the groove 51 is calculated, the center position of the groove bottom portion 55 in the width direction may not be calculated. In a case in which the plate-shaped workpiece 11 is divided to manufacture chips, after the calculation of the shape of the groove 51, with reference to the calculated shape of the groove 51, and the dividing grooves are formed in the plate-shaped workpiece 11 along the dividing lines 13, so that the plate-shaped workpiece 11 is divided to form chips (S50). As described above, according to one mode of the present invention, also in a case in which the cross section of the groove 51 is not symmetrical, the shape of the groove 51 can be calculated. In addition, with reference to the calculated shape of the groove 51, the dividing grooves are formed along the dividing lines 13, so that chips can be manufactured.

Moreover, regarding the plate-shaped workpiece 11 formed with such grooves 61 as illustrated in FIG. 8B along the dividing lines 13, the shape of the groove 61 may be calculated. The groove 61 becomes steeper from one end portion 61a toward a groove bottom portion 65a. Further, a first side portion 63a on the one end portion 61a side is vertical to the front surface 11a of the plate-shaped workpiece 11. In addition, the groove bottom portion 65a positioned between the first side portion 63a and a second side portion 63b does not have a substantial width and is not in a planar shape, and is in a linear shape extending along the dividing lines 13. The second side portion 63b is an inclined surface that is steeper from the groove bottom portion 65a to an end portion 61b. In this manner, the groove 61 illustrated in FIG. 8B is not also symmetrical.

Also in this case, first, the plate-shaped workpiece 11 is supported (held under suction) on the support table (chuck table) 8 (S10), and the distance measuring unit (imaging camera 38) is positioned in such a manner as to face part of the groove 61 of the plate-shaped workpiece 11 (S20). Then, two or more of the measurement points 27 are set on the inner surface of the groove 61 such that the positions of the measurement points 27 in the width direction of the groove 61 are different from each other, and as illustrated in FIG. 8B, the information regarding the height of each of the measurement points 27 is acquired with use of the distance measuring unit (imaging camera 38).

For example, in a case in which, according to the height positions of the plurality of measurement points 27, it is checked that the measurement points 27 are arranged on the inclined surface with a predetermined slope, it is understood that these measurement points 27 are set on the second side portion 63b. In addition, in a case in which, among the plurality of measurement points 27, the measurement point 27 farthest from the end portion 61b of the groove 61 is significantly different in height position from the adjacent measurement point 27, it is understood that the vertical first side portion 63a is located between these two measurement points 27. In this manner, according to the information regarding the height of each of the measurement points 27, the shape of the groove 61 is calculated (S43). Note that, when the shape of the groove 61 is calculated, the center position of the groove bottom portion 65a in the width direction may be calculated. Alternatively, when the shape of the groove 61 is calculated, the center position of the groove bottom portion 65a in the width direction may not be calculated. In a case in which the plate-shaped workpiece 11 is divided to manufacture chips, after the calculation of the shape of the groove 61, the dividing grooves are formed along the dividing lines 13 in the plate-shaped workpiece 11 with reference to the calculated shape of the groove 61, and the plate-shaped workpiece 11 is divided to form chips (S50).

As described above, according to one mode of the present invention, also in a case in which the cross section of the groove 61 is not symmetrical, the shape of the groove 61 can be calculated. Moreover, with reference to the calculated shape of the groove 61, the dividing grooves are formed along the dividing lines 13, so that chips can be manufactured.

Note that, in the embodiment above, a case in which the plate-shaped workpiece 11 is cut, with use of the cutting blade 46, to form the dividing grooves 29 in the plate-shaped workpiece 11 has been described. However, the method of forming the dividing grooves 29 is not limited to such details. For example, the dividing grooves 29 may be formed in the plate-shaped workpiece 11 by applying a laser beam of a wavelength absorbable by the plate-shaped workpiece 11 to the plate-shaped workpiece 11 along the dividing lines 13. That is, the dividing grooves 29 may be formed in the plate-shaped workpiece 11 by laser ablation. In addition, the dividing grooves 29 may be formed by applying and focusing a laser beam of a wavelength transmissible through the plate-shaped workpiece 11 along the dividing lines 13, forming modified layers in the plate-shaped workpiece 11, and applying an external force to the plate-shaped workpiece 11 formed with the modified layers. Further, the dividing grooves 29 may be formed in the plate-shaped workpiece 11 by subjecting the plate-shaped workpiece 11 to plasma etching along the dividing lines 13. In this case, a portion of the front surface 11a of the plate-shaped workpiece 11 other than a region where the dividing grooves 29 are to be formed is covered with a resist film, and the plate-shaped workpiece 11 is loaded into a plasma etching apparatus. Then, the plate-shaped workpiece 11 is subjected to plasma etching, and after the dividing grooves 29 are formed in the plate-shaped workpiece 11, the resist film is removed.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A calculating method of calculating a shape of a groove formed along a direction parallel to a front surface of a plate-shaped workpiece, comprising:
positioning a distance measuring unit in such a manner as to face part of the groove of the plate-shaped workpiece;
acquiring, with use of the distance measuring unit, information regarding a height of each of two or more of measurement points set in the groove such that positions of the measurement points in a width direction of the groove are different from each other; and
calculating the shape of the groove according to the acquired information regarding the height of each of the measurement points.

2. The calculating method according to claim 1,
wherein the distance measuring unit is a laser rangefinder.

3. The calculating method according to claim 1,
wherein the distance measuring unit is an imaging camera, and the imaging camera is focused at a specific position, thereby making it possible to determine that the specific position is spaced apart from the imaging camera by a predetermined distance.

4. A chip manufacturing method of dividing a plate-shaped workpiece along a plurality of dividing lines set along a front surface of the plate-shaped workpiece to manufacture chips, the method comprising:
positioning a distance measuring unit in such a manner as to face part of a groove formed in the plate-shaped workpiece along each of the dividing lines;
acquiring, with use of the distance measuring unit, information regarding a height of each of two or more of measurement points set in the groove such that positions of the measurement points in a width direction of the groove are different from each other;
calculating a shape of the groove according to the acquired information regarding the height of each of the measurement points; and
forming a dividing groove along each of the dividing lines in the plate-shaped workpiece with reference to the calculated shape of the groove and dividing the plate-shaped workpiece to form chips.

5. The chip manufacturing method according to claim 4,
wherein the dividing groove is formed in the plate-shaped workpiece by any of cutting the plate-shaped workpiece with a cutting blade, applying a laser beam of a wavelength absorbable by the plate-shaped workpiece to the plate-shaped workpiece, focusing a laser beam of a wavelength transmissible through the plate-shaped workpiece in the plate-shaped workpiece to form modified layers in the plate-shaped workpiece and apply an external force to the plate-shaped workpiece formed with the modified layers, and subjecting the plate-shaped workpiece to plasma etching along the dividing lines.

6. A detecting apparatus which detects a shape of a groove formed along a direction parallel to a front surface of a plate-shaped workpiece, comprising:
a support table capable of supporting the plate-shaped workpiece; and
a distance measuring unit which faces the plate-shaped workpiece supported on the support table and measures a distance to a measurement point set in the plate-shaped workpiece,
wherein the plate-shaped workpiece is supported on the support table, the distance measuring unit is positioned in such a manner as to face part of a groove of the plate-shaped workpiece, information regarding a height of each of two or more measurement points set on an inner surface of the groove such that positions of the measurement points in a width direction of the groove are different from each other is acquired with use of the distance measuring unit, and the shape of the groove is calculated according to the acquired information regarding the height of each of the measurement points.
